(19) United States
(12) Patent Application Publication
(10) Pub. No.: US 2011/0067962 A1
(43) Pub. Date: Mar. 24, 2011

(54) VEHICLE HYDRAULIC CONTROL DEVICE

(75) Inventors: Takayoshi YONEZU, Aichi-ken (JP); Yuhei Yoshioka, Aichi-ken (JP); Kazuyuki Noda, Aichi-ken (JP); Kazuhito Enomoto, Aichi-ken (JP)

(73) Assignee: AISIN AW CO., LTD., Anjo-shi (JP)

(21) Appl. No.: 12/862,167

(22) Filed: Aug. 24, 2010

(30) Foreign Application Priority Data
Sep. 18, 2009 (JP) 2009-218123
Mar. 10, 2010 (JP) 2010-053763

(51) Int. Cl. F16D 65/32; F16D 65/14

(52) U.S. Cl. 188/152

(57) ABSTRACT

A vehicle hydraulic control device for driving a parking rod to a parking disengagement position and a parking engagement position, and switching a shift range at least between a parking range and a non-parking range by switching an engagement state of a parking gear and a parking pole. The vehicle hydraulic control device includes a parking cylinder and a switch valve. The parking cylinder receives an oil pressure for driving the parking rod to the parking disengagement position. The switch valve is driven based on an electric actuator and switches an operation state between a parking disengagement state in which a source pressure from an oil pressure supply source is supplied to the parking cylinder as a disengagement pressure for disengaging the parking gear and the parking pole from each other, and a parking engagement state in which the disengagement pressure is not supplied to the parking cylinder.

### INCORPORATION BY REFERENCE

The disclosure of Japanese Patent Application No. 2010-053763 filed on Mar. 10, 2010 and Japanese Patent Application No. 2009-218123 filed on Sep. 18, 2009 including the specification, drawings and abstract is incorporated herein by reference in its entirety.

### BACKGROUND OF THE INVENTION

The present invention relates to a vehicle hydraulic control device that is mounted on a vehicle, and more particularly to a structure in which a parking state of the vehicle is established and released.

### DESCRIPTION OF THE RELATED ART

A multi-stage automatic transmission, which is mounted on a vehicle such as an automobile, is hydraulically controlled so that a plurality of (e.g., two) friction engagement elements (clutches and brakes) are engaged according to a shift speed in order to form a transmission path of a shift gear mechanism. A hydraulic control device that performs such hydraulic control has a mechanism to set a range pressure in accordance with a selected shift range. A structure is known in which such a range pressure is set based on an electric signal (so-called shift-by-wire system).

On the other hand, an automatic transmission has a parking mechanism to prevent rotation of an output shaft by a mechanical unit. This parking mechanism establishes a parking state and releases the parking state by, e.g., engaging and disengaging a parking pole with and from a parking gear fixed to the output shaft. In the case of the automatic transmission having such a shift-by-wire mechanism, since a shift operation portion (a shift lever) and a mechanism to drive the parking pole are not mechanically lined together, the mechanism to drive the parking pole is required.

One known example of such a mechanism is a structure in which a motor for driving a manual shift valve for setting a range pressure based on an electric signal that is output in accordance with a shift range is used as a driving source for driving a parking mechanism (see Japanese Patent Application Publication No. JP-A-H06-193729). In the structure described in Japanese Patent Application Publication No. JP-A-H06-193729, the driving force of the motor is transmitted to the parking mechanism through a deceleration mechanism. Another known example is a structure in which a motor that drives a manual shift valve and a motor that drives a parking mechanism are provided separately (see Japanese Patent Application Publication No. JP-A-2004-169877).

### SUMMARY OF THE INVENTION

A large force is required to disengage the parking mechanism. That is, the parking gear and the parking pole are engaged with each other in the parking state. These engaged portions may be subjected to a large force while, e.g., a vehicle is stopping on a slope. Thus, a large force is required to disengage these engaged portions.

Accordingly, in the structure described in Japanese Patent Application Publication No. JP-A-H06-193729, a motor output needs to be increased, and/or the gear size of the deceleration mechanism needs to be increased, which necessarily increases the size of the structure. In the structure described in Japanese Patent Application Publication No. JP-A-2004-169877 as well, a high output motor needs to be used to drive the parking mechanism, which necessarily increases the size of the structure. Such an increase in size of the structure makes it difficult to incorporate the structure into an automatic transmission, which hinders mountability to a vehicle.

The structure described in Japanese Patent Application Publication No. JP-A-H06-193729 has the deceleration mechanism, which makes the structure complex. Moreover, the structure of Japanese Patent Application Publication No. JP-A-H06-193729 needs to use a high output motor, which necessarily increases manufacturing cost. The structure described in Japanese Patent Application Publication No. JP-A-2004-169877 also requires a high output motor, which necessarily increases manufacturing cost.

It is an object of the present invention to implement a vehicle hydraulic control device that requires neither a high output electric actuator nor a deceleration mechanism, and thus can reduce the size and cost.

The present invention according to a first aspect is a vehicle hydraulic control device for driving a parking rod to a parking disengagement position and a parking engagement position based on an operation input of a shift selecting portion, and switching a shift range at least between a parking range and a non-parking range by switching an engagement state of a parking gear and a parking pole including: a parking cylinder that receives an oil pressure for driving the parking rod to the parking disengagement position; and a switch valve that is driven based on an electric actuator and switches an operation state between a parking disengagement state in which a source pressure from an oil pressure supply source is supplied to the parking cylinder as a disengagement pressure for disengaging the parking gear and the parking pole from each other, and a parking engagement state in which the disengagement pressure is not supplied to the parking cylinder.

The present invention according to a second aspect is the vehicle hydraulic control device according to the first aspect in which the switch valve is a manual shift valve that sets a forward range pressure and a reverse range pressure based on the source pressure.

The present invention according to a third aspect is the vehicle hydraulic control device according to the second aspect in which the manual shift valve is structured to supply the source pressure to the parking cylinder as the disengagement pressure when a shift range is any of a forward range, a neutral range, and a reverse range, and to cut off the source pressure and drain the disengagement pressure so that the disengagement pressure is not supplied to the parking cylinder, when the shift range is the parking range.

The present invention according to a fourth aspect is the vehicle hydraulic control device according to the third aspect in which the manual shift valve includes a plurality of ports, and a spool for selectively causing the plurality of ports to communicate with or disconnect from each other, based on a position to which the spool is moved, a first drain port, a discharge port for guiding the forward range pressure to the first drain port, a forward range port for supplying the forward range pressure, an input port for receiving the source pressure, a reverse range port for supplying and discharging the reverse range pressure, and a second drain port, all of which form the plurality of ports, are sequentially positioned with respect to a direction in which the spool is moved, ports for supplying and discharging the disengagement pressure to and from the parking cylinder, which form the plurality of ports, are positioned between the discharge port and the forward range port and between the input port and the reverse range port, and the disengagement pressure is drained from the first drain port and the second drain port when the shift range is the parking range.

The present invention according to a fifth aspect is the vehicle hydraulic control device according to the second aspect in which the manual shift valve is capable of setting a neutral range pressure, the vehicle hydraulic control device further includes a check valve mechanism positioned between the manual shift valve and the parking cylinder, and capable of supplying any of the forward range pressure, the reverse range pressure, and the neutral range pressure to the parking cylinder as the disengagement pressure, when the shift range is any of a forward range, a neutral range, and a reverse range, the range pressure corresponding to the range is supplied to the parking cylinder through the check valve mechanism as the disengagement pressure, and when the shift range is the parking range, the range pressure is cut off by the manual shift valve, and the disengagement pressure is drained so that the disengagement pressure is not supplied to the parking cylinder.

The present invention according to a sixth aspect is the vehicle hydraulic control device according to the first or second aspect further including a relay valve capable of supplying the source pressure to the parking cylinder as the disengagement pressure, wherein the switch valve is structured to supply the oil pressure to the relay valve when the operation state is one of the parking disengagement state and the parking engagement state, and not to supply the oil pressure when the operation state is the other state, and the relay valve is structured to supply or not to supply the disengagement pressure according to whether or not the oil pressure is supplied from the switch valve.

The present invention according to a seventh aspect is the vehicle hydraulic control device according to any one of the first to sixth aspects in which the parking cylinder includes a holding mechanism that holds a disengaged position of the parking rod.

In the present invention according to the first aspect, neither a high output electric actuator nor a deceleration mechanism is required, whereby the size and cost can be reduced. That is, an operation of driving the parking rod to the disengagement position, which requires a large force, is performed by an oil pressure, and an operation of switching the switch valve, which requires only a small force, is performed by an electric actuator. This eliminates the need to provide separate electric actuators for these operations, and also eliminates the need to use a high output electric actuator and to provide a deceleration mechanism. Thus, the size and cost of the device can be reduced.

In the present invention according to the second aspect, the manual shift valve is used as the switch valve. This eliminates the need to provide an additional switch valve for performing engagement and disengagement for parking, whereby the size and cost can further be reduced.

In the present invention according to the third aspect, the manual shift valve need only be structured to be able to supply the disengagement pressure, and no valve or the like need be additionally provided. Thus, the size and cost can further be reduced.

In the present invention according to the fourth aspect, the disengagement pressure is drained from the first drain port and the second drain port when the shift range is the parking range. This can reduce the time it takes to drain the disengagement pressure when the shift range is switched from the forward range or the reverse range to the parking range, whereby responsiveness when driving the parking rod to the parking engagement position is improved.

In the present invention according to the fifth aspect, the check valve mechanism is provided between the manual shift valve and the parking cylinder. Since this check valve mechanism is neither bulky nor complex in structure, the size and cost can be reduced.

In the present invention according to the sixth aspect, the relay valve is provided in addition to the switch valve. Since this relay valve is neither bulky nor complex in structure, the size and cost can be reduced.

In the present invention according to the seventh aspect, in the case where the oil pressure is supplied to the parking cylinder to release the parking state, the parking state can be maintained even if supply of the oil pressure is stopped.

### BRIEF DESCRIPTION OF THE DRAWINGS

FIG. 1 is a schematic, partially cut-away perspective view of a parking mechanism according to an embodiment of the present invention;

FIGS. 2A to 2D show schematic partial cross-sectional views of a vehicle hydraulic control device according to a first embodiment, where FIG. 2A shows a state in a parking range, FIG. 2B shows a state in a reverse range, FIG. 2C shows a state in a neutral range, and FIG. 2D shows a state in a forward range;

FIGS. 3A to 3D show schematic partial cross-sectional views of a vehicle hydraulic control device according to a second embodiment, where FIG. 3A shows a state in a parking range, FIG. 3B shows a state in a reverse range, FIG. 3C shows a state in a neutral range, and FIG. 3D shows a state in a forward range;

FIG. 4 is a schematic diagram of a vehicle hydraulic control device according to a third embodiment; and

FIGS. 5A and 5B show schematic diagrams of a vehicle hydraulic control device according to a fourth embodiment, where FIG. 5A shows a state in a parking range, and FIG. 5B shows a state in any of a reverse range, a neutral range, and a forward range.

### DETAILED DESCRIPTION OF THE EMBODIMENTS

### First Embodiment

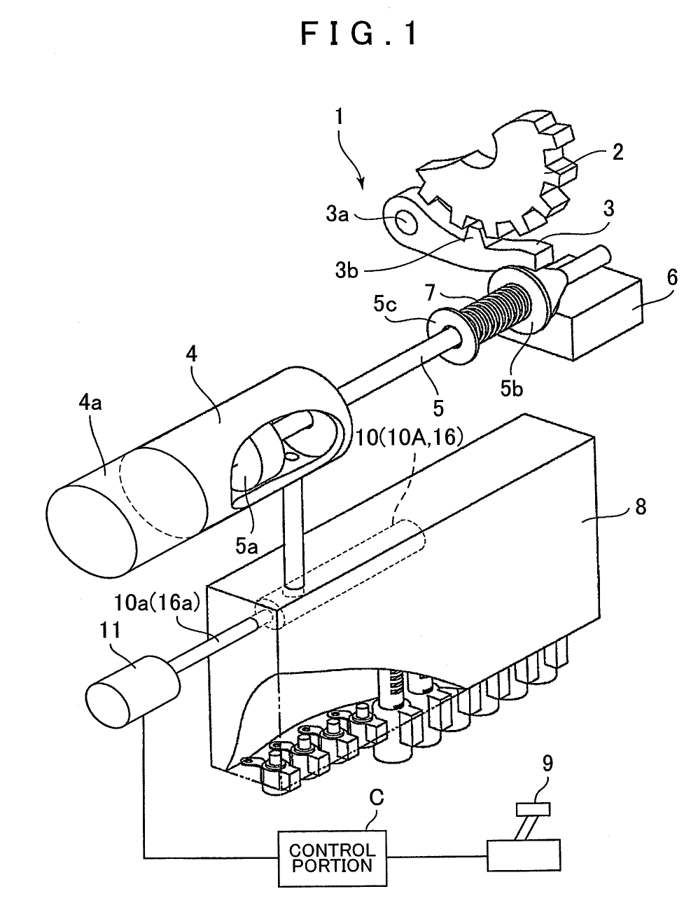

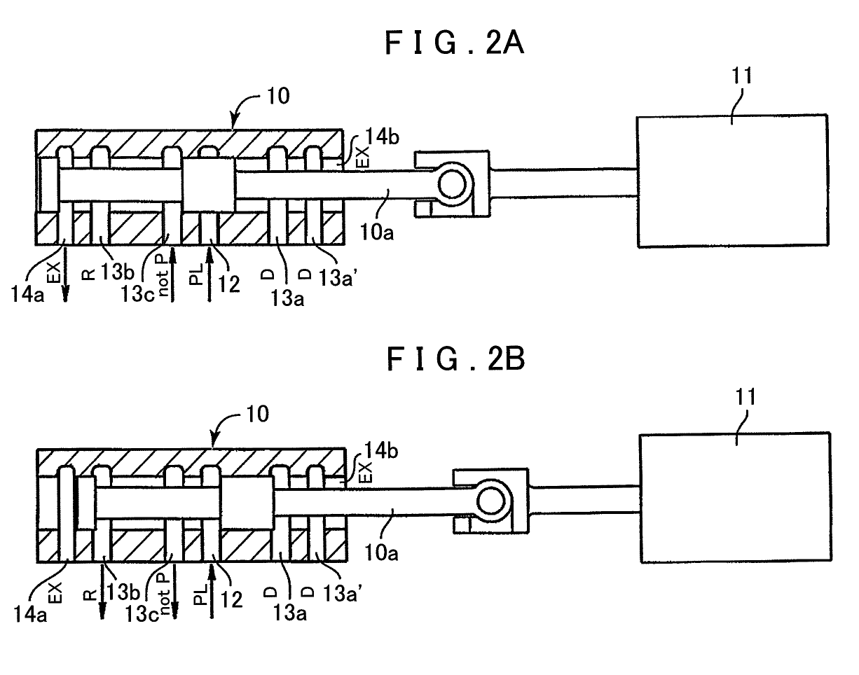

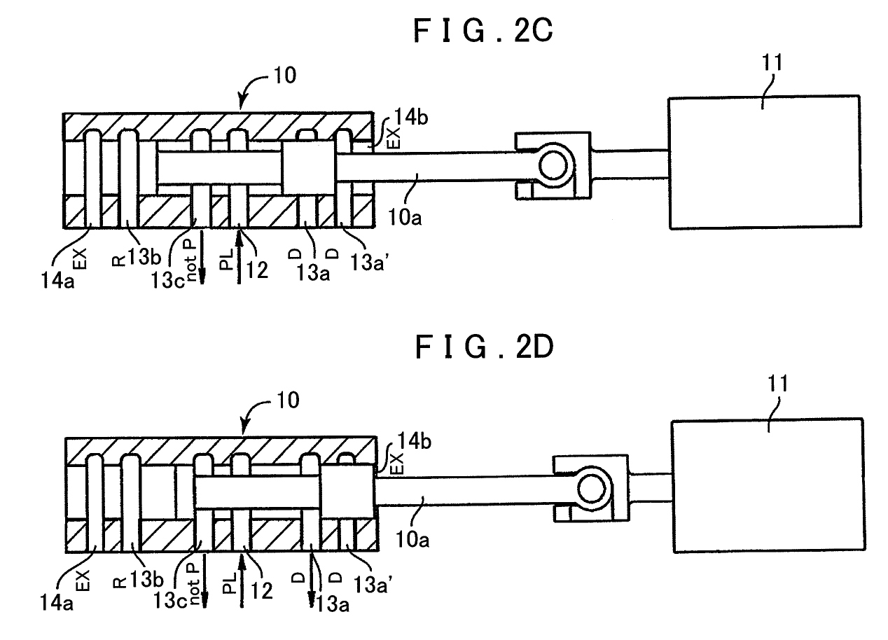

A first embodiment of the present invention will be described below with reference to FIG. 1 and FIGS. 2A to 2D. First, an overview of a parking mechanism of the present embodiment will be described briefly with reference to FIG. 1. A parking mechanism 1 includes a parking gear 2, a parking pole 3, a parking cylinder 4, a parking rod 5, a support 6, and a spring 7 as a biasing member. The parking gear 2 has a plurality of teeth on its outer peripheral surface. The parking gear 2 is fixed to, e.g., an output shaft of an automatic transmission or the like, and rotates together with an output shaft of a vehicle.

The parking pole 3 is swingably positioned in a stationary portion of the vehicle so as to be able to be engaged with the parking gear 2. That is, a top end of the parking pole 3 is swingable about a support shaft 3a that is supported by the stationary portion. A pawl 3b is provided in an intermediate portion of the parking pole 3 so as to protrude toward the parking gear 2. The pawl 3b is capable of entering each space between the teeth of the parking gear 2.

The parking cylinder 4 is positioned adjacent to a valve body 8 of the automatic transmission. The parking rod 5 is capable of being driven by supplying and discharging an oil pressure from the valve body 8 to and from the parking cylinder 4.

A piston 5a is fixed to a base end of the parking rod 5, and a substantially conical wedge 5b is fixed to a top end of the parking rod 5. The piston 5a is positioned in the parking cylinder 4, so that the parking rod 5 can be driven in a direction in which the parking rod 5 is drawn into the parking cylinder 4, by supplying an oil pressure into the parking cylinder 4. The wedge 5b is engaged with a portion close to a top end of the parking pole 3, so that the parking pole 3 can swing about the support shaft 3b as the wedge 5b moves axially.

The support 6 is placed in the stationary portion of the vehicle, and is positioned at a predetermined distance from the parking pole 3 so as to face the parking pole 3 with the wedge 5b of the parking rod 5 interposed therebetween. The support 6 supports the wedge 5b when the wedge 5b moves axially to swing the parking pole 3. That is, the wedge 5b swings the top end of the parking pole 3 by entering a space between the top end of the parking pole 3 and the support 6 and engaging the top end of the parking pole 3 and the support 6.

The spring 7 is disposed around a part of the parking rod 5, which is close to a top end of the parking rod 5. The spring 7 biases the parking rod 5 in a direction opposite to the parking cylinder 4. That is, the spring 7 is positioned between the wedge 5b and a flange portion 5c that is positioned in the stationary portion of the vehicle (an automatic transmission case, not shown), in an elastically compressed state. Thus, due to an elastic restoring force of the spring 7, the parking rod 5 is biased in the direction opposite to the parking cylinder 4 via the wedge 5b. Note that the biasing member for biasing the parking rod 5 in this manner may be an elastic member such as rubber, and may be placed at other positions such as, e.g., in the parking cylinder 4.

The parking mechanism 1 further includes a holding mechanism 4a that is adjoined to the parking cylinder 4, and fixes and holds the piston 5a. In the case where an oil pressure is supplied to the parking cylinder 4 to release a parking state (if the parking rod 5 is at a parking disengagement position), the holding mechanism 4a mechanically fixes and holds the piston 5a so that the parking rod 5 can be held at the parking disengagement position, even if supply of the oil pressure is stopped. Note that the holding mechanism 4a may be a mechanism capable of electrically fixing and holding the piston 5a.

The parking mechanism 1 structured as described above is operated by supplying and discharging an oil pressure from the valve body 8. That is, as described below, the oil pressure from the valve body 8 is supplied to and discharged from the parking cylinder 4 so that the parking rod 5 can be switched between a parking engagement position and the parking disengagement position of the parking gear 2 and the parking pole 3. If the oil pressure is discharged from the parking cylinder 4, the parking rod 5 is biased by the elastic force of the spring 7 to move in the direction opposite to the parking cylinder 4. According to engagement with the wedge 5b, the parking pole 3 swings toward the parking gear 2, and the pawl 3b meshes (engages) with the parking gear 2, thereby preventing rotation of the parking gear 2. This also prevents rotation of the output shaft of the vehicle, bringing the vehicle into a parking state.

On the other hand, if the oil pressure is supplied from the valve body 8 into the parking cylinder 4 as a disengagement pressure, the piston 5a is pressed by the disengagement pressure, and the parking rod 5 moves toward the parking cylinder 4 against the elastic force of the spring 7. At this time, according to engagement with the wedge 5b, the parking pole 3 swings in a direction away from the parking gear 2, and the pawl 3b is disengaged from the parking gear 2. Thus, the parking gear 2 and the output shaft of the vehicle become rotatable, whereby the parking state is released.

The vehicle hydraulic control device for supplying and discharging the disengagement pressure as described above will be described below with reference to FIG. 1 and FIGS. 2A to 2D. A manual shift valve 10 is positioned in the valve body 8 of the automatic transmission. The manual shift valve 10 is capable of setting a forward range (D range) pressure and a reverse range (R range) pressure based on a source pressure according to a shift range selected by a shift lever 9 as a shift selecting portion. The manual shift valve 10 sets these range pressures by switching ports by moving a spool 10a based on an operation input of the shift lever 9. That is, the manual shift valve 10 includes a plurality of ports, and the spool 10a for selectively causing the plurality of ports to communicate with each other or to disconnect from each other according to the position to which the spool 10a is moved. The manual shift valve 10 sets these range pressures by moving the spool 10a. In the present embodiment, the manual shift valve 10 corresponds to a switch valve.

In the present embodiment, the shift range is selected by a shift-by-wire system. Thus, the spool 10a is driven by a motor 11 such as a stepping motor as an electric actuator. That is, the motor 11 is driven based on an electric signal that is sent via a control portion C according to an operation of the shift lever 9, whereby the spool 10a is moved axially. Thus, a range pressure according to the shift range is set by the manual shift valve 10, and this range pressure is supplied to a hydraulic circuit, not shown, thereby controlling the automatic transmission.

In the present embodiment, the manual shift valve 10 is structured to be able to output the disengagement pressure when the shift range is any of a forward range, a neutral range (N range), a reverse range (that is, when the shift range is a non-parking range). That is, the manual shift valve 10 has an input port 12, output ports 13a, 13b, 13c, drain ports (EXs) 14a, 14b, and a discharge port 13a′. A line pressure PL as a source pressure is supplied to the input port 12. The line pressure PL is generated via a primary regulator valve by an oil pump that is driven by a driving source (e.g., an engine), not shown, of the vehicle. The output port 13a is a port for outputting the D range pressure, the output port 13b is a port for outputting the R range pressure, the output port 13c is a port for outputting the disengagement pressure (a not-P pressure), and the discharge port 13a′ is a port that is caused to communicate with the drain port 14b to first guide the D range pressure to the drain port 14b, when the shift range is switched from the D range to other range. Thus, the output ports 13a, 13b and the discharge port 13a′ are connected to a predetermined hydraulic circuit in the valve body 8, and the output port 13c is connected to the parking cylinder 4 described above. Note that an orifice is provided between the discharge port 13a′ and the parking cylinder 4 to prevent the D range pressure from being rapidly discharged when the shift range is switched from the D range to other range.

The hydraulic control device structured as described above operates as described below. First, when a parking range (a P range) is selected by the shift lever 9, the spool 10a is moved by the motor 11 as shown in FIG. 2A, so that the input port 12 is blocked, and the output port 13c and the drain port 14a communicate with each other. Thus, the disengagement pressure having been supplied to the parking cylinder 4 is drained through the drain port 14a, and no disengagement pressure is supplied into the parking cylinder 4. As a result, as described above, the parking rod 5 is biased by the spring 7, enabling the pawl 3b of the parking pole 3 to engage with the parking gear 2. In the present embodiment, this state is a parking engagement state.

On the other hand, if the R range is selected by the shift lever 9, the spool 10a is moved by the motor 11 as shown in FIG. 2B, so that the input port 12 is opened and communicates with the output ports 13b, 13c. Moreover, the output ports 13b, 13c are disconnected from the drain ports 14a, 14b. Thus, the R range pressure is output from the output port 13b, and the disengagement pressure is output from the output port 13c. As a result, the automatic transmission is set to the R range, and the disengagement pressure is supplied into the parking cylinder 4.

If the N range is selected by the shift lever 9, the spool 10a is moved by the motor 11 as shown in FIG. 2C, so that the input port 12 is opened and communicate with the output port 13c. Moreover, the output port 13c is disconnected from the drain ports 14a, 14b. Thus, the disengagement pressure is output from the output port 13c. As a result, the automatic transmission is set to the N range, and the disengagement pressure is supplied into the parking cylinder 4.

If the D range is selected by the shift lever 9, the spool 10a is moved by the motor 11 as shown in FIG. 2D, whereby the input port 12 is opened and communicates with the output ports 13a, 13c. Moreover, the output ports 13a, 13c are disconnected from the drain ports 14a, 14b. Thus, the D range pressure is output from the output port 13a, and the disengagement pressure is output from the output port 13c. As a result, the automatic transmission is set to the D range, and the disengagement pressure is supplied into the parking cylinder 4. Note that if the shift range is switched from the D range to, e.g., the N range, the spool 10a is moved to the position of FIG. 2C, where the discharge port 13a′ and the drain port 14b communicate with each other, and the D range pressure is gradually discharged.

As described above, in the present embodiment, the line pressure PL is supplied as the disengagement pressure into the parking cylinder 4 by the manual shift valve 10 when the shift range is any of the D range, the N range, and the R range. As a result, as described above, the parking rod 5 is moved against the biasing force of the spring 7, disengaging the pawl 3b of the parking pole 3 from the parking gear 2. In the present embodiment, this state is a parking disengagement state.

In the present embodiment, neither a high output motor nor a deceleration mechanism is required, whereby the size and cost can be reduced. That is, a large force can be required to disengage the parking gear 2 and the parking pole 3 from each other (from the state where the parking gear 2 and the parking pole 3 mesh with each other). In the present embodiment, the line pressure PL is supplied as the disengagement pressure into the parking cylinder 4 via the manual shift valve 10, thereby driving the parking rod 5 to the parking disengagement position. Thus, a large force can be applied to disengage the parking gear 2 and the parking pole 3 from each other. As a result, a motor having an output that is merely large enough to move the spool 10a can be used as the motor 11 for switching the manual shift valve 10, whereby the size and cost of the motor 11 can be reduced. Moreover, no deceleration mechanism is required to transmit the driving force of the motor 11 to disengage the parking gear 2 and the parking pole 3 from each other. Thus, the overall size and cost of the device can be reduced. Since the size of the motor 11 can be reduced, and no deceleration mechanism is required, the hydraulic control device can be satisfactorily mounted on vehicles.

In the present embodiment, the manual shift valve 10 is used as a switch valve for supplying and discharging the disengagement pressure to and from the parking cylinder 4. Thus, no switch valve need be separately provided to implement engagement and disengagement for the parking state, whereby the size and cost can further be reduced. Moreover, since the manual shift valve 10 need only be able to supply the disengagement pressure, no valve or the like need be separately provided. Thus, the size and cost can further be reduced. Moreover, a shift-by-wire mechanism can be implemented by slightly changing existing automatic transmissions.

### Second Embodiment

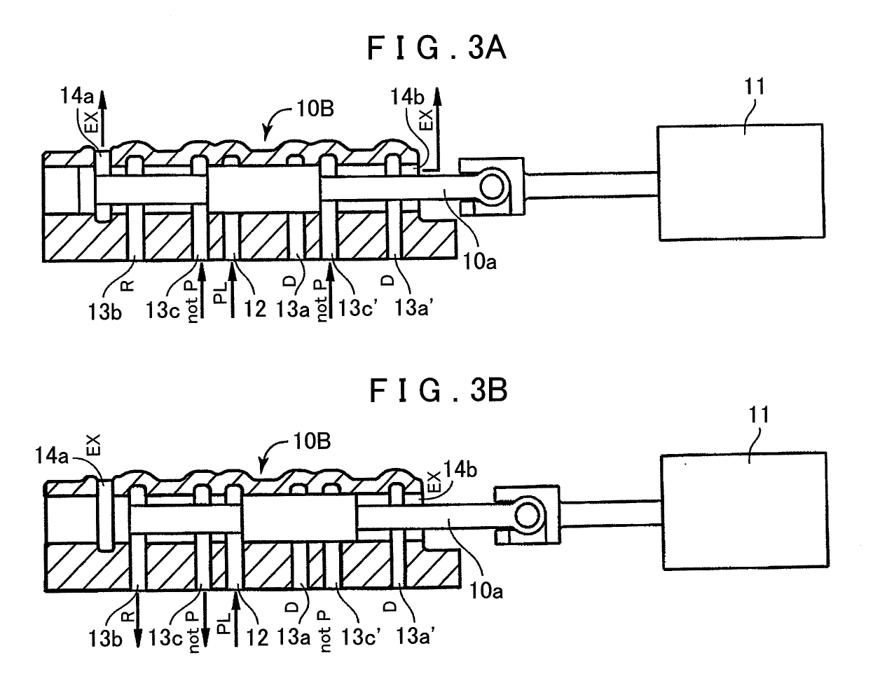

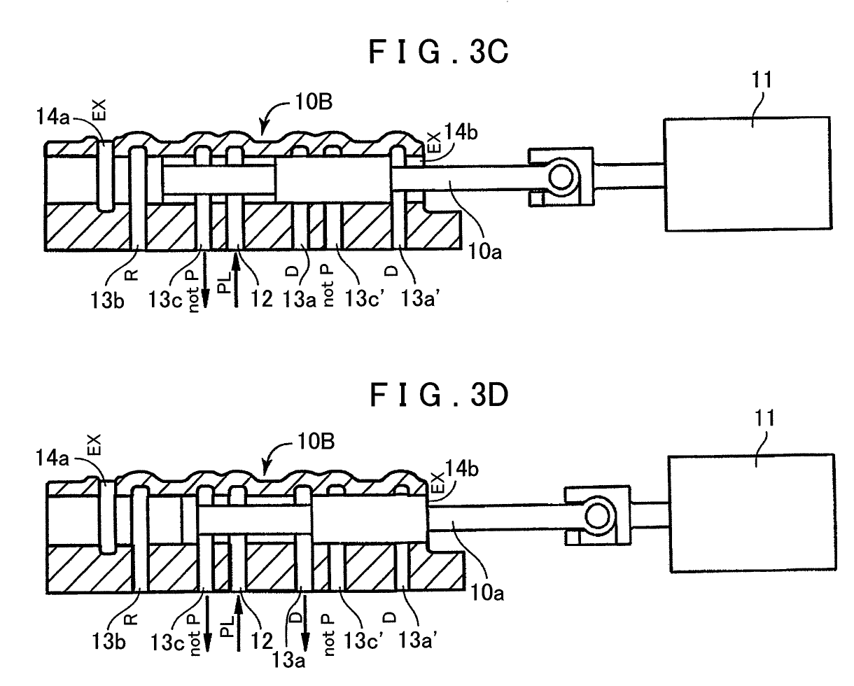

A second embodiment of the present invention will be described with reference to FIG. 1 and FIGS. 3A to 3D. Note that since the parking mechanism shown in FIG. 1 is similar to that of the first embodiment described above, description thereof is omitted. A basic structure of a manual shift valve 10B is similar to that of the first embodiment except for the number of ports. Thus, repetitive description of the first embodiment is omitted or given briefly, and differences from the first embodiment will be mainly described.

The present embodiment is different from the first embodiment in that a port for guiding the disengagement pressure of the parking cylinder 4 to the drain port is added, and a discharge port 13c′, which is the added port, is positioned adjacent to the output port 13a for the D range pressure. That is, in the manual shift valve 10B of the present embodiment, the drain port (EX) 14b on the D range side, the discharge port 13a′ for the D range pressure, the discharge port 13c′ for the disengagement pressure (not-P), the output port 13a for the D range pressure, the input port 12 for the line pressure (PL) as a source pressure, the output port 13c for the disengagement pressure (not-P), the output port 13b for the R range pressure, and the drain port (EX) 14a on the R range side are sequentially positioned from the right in FIGS. 3A to 3D in a direction in which the spool 10a is moved (a lateral direction in FIGS. 3A to 3D). The manual shift valve 10B is structured to drain the disengagement pressure from the drain port 14b on the D range side and the drain port 14a on the R range side when the shift range is the parking range (the P range).

Note that, in the present embodiment, the discharge port 13c′ merely discharges the disengagement pressure when the shift range is the D range. However, the manual shift valve 10B may be structured so that the disengagement pressure can be supplied from the discharge port 13c′ into the parking cylinder 4 (the discharge port 13c′ can function as an output port) according to the position of the spool 10a. For example, when the shift range is the D range (FIG. 3D), the output port 13c may be blocked, and the disengagement pressure may be supplied from the discharge port 13c′.

The drain port 14b is a first drain port, the discharge port 13a′ is a discharge port for guiding the forward range pressure to the drain port 14b, the output port 13a is a forward range port for supplying the forward range pressure, the output port 13b is a reverse range port for supplying and discharging the reverse range pressure, the drain port 14a is a second drain port, and the discharge port 13c′ and the output port 13c are ports for supplying and discharging the disengagement pressure to and from the parking cylinder 4. In the present embodiment, these ports together with the input port 12 form the plurality of ports, and the plurality of ports are caused to communicate with or disconnect from each other, based on the position to which the spool 10a is moved.

According to the present embodiment, the manual shift valve 10B is structured to drain the disengagement pressure from the drain port 14b on the D range side and the drain port 14a on the R range side when the shift range is the parking range. This can reduce the time it takes to drain the disengagement pressure when the shift range is switched from the D range or the R range to the parking range, whereby responsiveness when driving the parking rod 5 (see FIG. 1) to the parking engagement position is improved.

That is, the shift ranges of the shift lever 9 are typically positioned in the order of P, R, N, and D range. In the first embodiment, there is only one output port 13c for supplying and discharging the disengagement pressure to and from the parking cylinder 4, and the output port 13c is positioned adjacent to the output port 13b for the R range pressure. In such a case, if the P range is selected in the R range state, the R range pressure and the disengagement pressure are simultaneously drained from the drain port 14a on the R range side. Thus, it takes a long time to drain the R range pressure and the disengagement pressure. Since the parking rod 5 is not moved to the parking engagement position until both of the pressures are drained. Thus, the parking range cannot be established with satisfactory responsiveness after the P range is selected.

In the present embodiment, however, when the shift range is the P range (FIG. 3A), the output port 13c for the disengagement pressure communicates with the drain port 14a on the R range side, and the discharge port 13c′ for the disengagement pressure communicates with the drain port 14b on the D range side. Thus, when the shift range is switched from the R range (FIG. 3B) to the P range (FIG. 3A), the disengagement pressure is actively drained from the drain port 14b on the D range side though the discharge port 13c′ having a large pressure difference. On the other hand, the R range pressure is drained from the drain port 14a on the R range side. Similarly, when the shift range is switched from the D range (FIG. 3D) to the P range (FIG. 3A), the disengagement pressure is actively drained from the drain port 14a on the R range side though the output port 13c having a large pressure difference. On the other hand, the D range pressure is drained from the drain port 14b on the D range side.

In the present embodiment, as described above, two drain ports are provided for two oil pressures, and the disengagement pressure actively flows into one of the two drain ports, which has a lower remaining oil pressure. This can reduce the time it takes to drain the disengagement pressure when the shift range is switched from the D range or the R range to the P range, whereby responsiveness when driving the parking rod 5 to the parking engagement position is improved.

### Third Embodiment

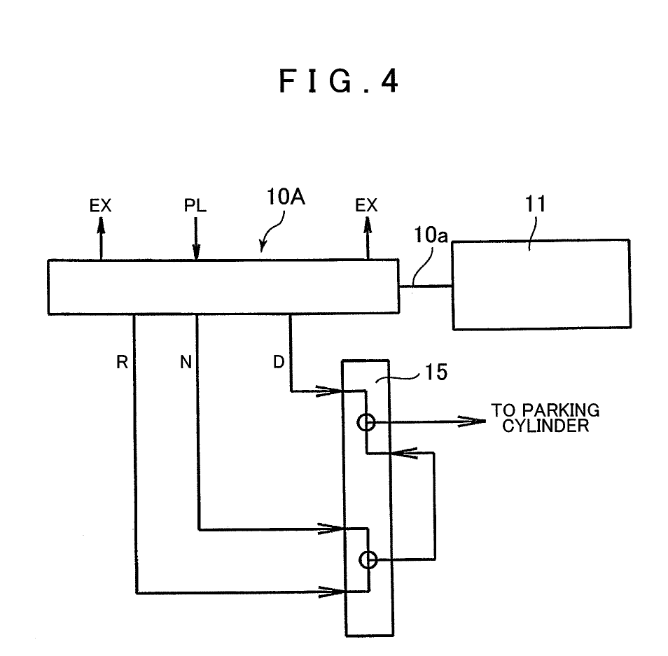

A third embodiment of the present invention will be described with reference to FIGS. 1 and 4. Note that since the parking mechanism shown in FIG. 1 is similar to that of the first embodiment described above, description thereof will be omitted. In the present embodiment, a manual shift valve 10A that is switched by the motor 11 is capable of setting a neutral range (N range) pressure in addition to the D range pressure and the R range pressure. That is, the manual shift valve 10A is provided with an output port, which communicates with the input port for receiving the line pressure PL when the N range is selected by the shift lever 9 and the spool 10a of the manual shift valve 10A is moved accordingly. Note that unlike the first embodiment, no output port for outputting the disengagement pressure is provided in the present embodiment.

In the present embodiment, a check valve mechanism 15 is positioned between the manual shift valve 10A and the parking cylinder 4. The output ports for outputting the D range pressure, the R range pressure, and the N range pressure are connected to the check valve mechanism 15. The check valve mechanism 15 combine oil passages connected to the output ports via check valves. In the illustrated example, the oil passages connected to the output ports for outputting the N range pressure and the R range pressure are combined together via a check valve, and the combined oil passage and the oil passage connected to the output port for outputting the D range pressure are combined together via a check valve. The oil passage thus obtained is connected to the parking cylinder 4. Thus, the check valve mechanism 15 is capable of supplying any of the D, R, and N range pressures to the parking cylinder 4 as the disengagement pressure. Note that combinations of the oil passages to be combined in the check valve mechanism 15 and the order in which the oil passages are combined can be changed as appropriate.

In the present embodiment, when the shift range is any of the D range, the N range, and the R range (a non-parking range), the range pressure corresponding to this range is supplied to the parking cylinder 4 via the check valve mechanism 15 as the disengagement pressure. As a result, the parking rod 5 is moved against the biasing force of the spring 7, disengaging the pawl 3b of the parking pole 3 from the parking gear 2. In the present embodiment, this state is a parking disengagement state.

On the other hand, when the shift range is the parking range, all of the range pressures are cut off by the manual shift valve 10A. At this time, the disengagement pressure in the parking cylinder 4 is drained from the drain port of the manual shift valve 10A via one of the oil passages of the check valve mechanism 15. No disengagement pressure is supplied to the parking cylinder 4. As a result, the parking rod 5 is biased by the spring 7, enabling the pawl 3b of the parking pole 3 to engage with the parking gear 2. In the present embodiment, this state is a parking engagement state.

According to the present embodiment, the check valve mechanism 15 is provided between the manual shift valve 10A and the parking cylinder 4. This check valve mechanism 15 is formed by merely providing the check valves in the combined portions of the oil passages. Thus, the check valve mechanism 15 is neither bulky nor complex in structure, whereby the size and cost can be reduced. The structures and functions are otherwise similar to those of the first embodiment.

### Fourth Embodiment

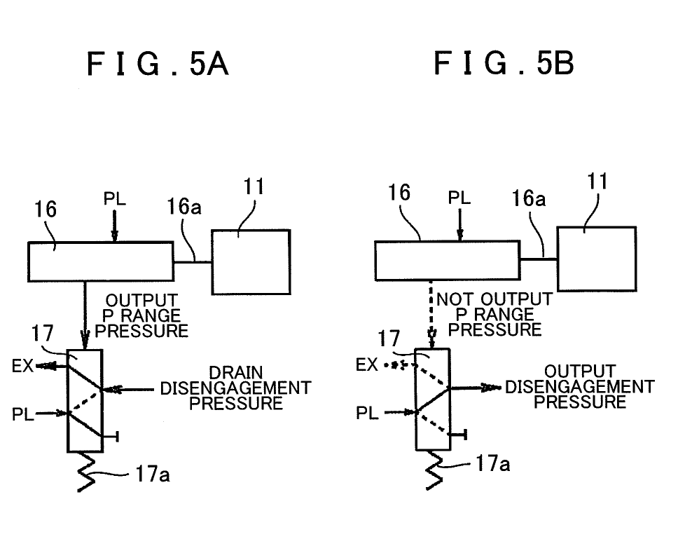

A fourth embodiment of the present invention will be described below with reference to FIG. 1 and FIGS. 5A and 5B. Note that since the parking mechanism shown in FIG. 1 is similar to that of the first embodiment described above, description thereof will be omitted. In the present embodiment, a switch valve 16 for switching between the parking disengagement state and the parking engagement state is a manual shift valve as in the first and second embodiments. However, a switch valve other than the manual shift valve may be used as the switch valve 16. For example, in the case where the present invention is applied to hybrid vehicles having no multi-stage automatic transmission and having a power dividing mechanism for dividing motive powers of an engine and a motor and outputting the divided motive powers, the hybrid vehicles include no such manual shift valve. Thus, in the structures including no manual shift valve, the switch valve 16 for outputting the P range (parking range) pressure when the P range is selected by the shift lever 9 may be provided instead of the manual shift valve.

The switch valve 16 has an input port for receiving the line pressure PL as a source pressure, and an output port for outputting the line pressure PL as the P range pressure when the P range is selected, and a spool 16a for switching the oil passages is driven by the motor 11. That is, when the P range is selected by the shift lever 9, the spool 16a is moved by driving the motor 11 based on a signal that is transmitted via the control portion C. Then, the input port and the output port are caused to communicate with each other, and the P range pressure is output from the output port. On the other hand, if the D range, the N range, or the R range, which is a range other than the P range, is selected by the shift lever 9, the spool 16a is moved by driving the motor 11 based on a signal transmitted via the control portion C. Then, for example, the input port and the output port are disconnected from each other, and the output port and a drain port are caused to communicate with each other to prevent the P range pressure from being output.

In the present embodiment, a relay valve 17 is positioned between the switch valve and the parking cylinder. The relay valve 17 has a line input port for receiving the line pressure PL, a P range input port for receiving the P range pressure, a disengagement pressure output port for supplying the line pressure PL to the parking cylinder 4 as a disengagement pressure, and a drain port for draining the disengagement pressure. A spool for switching the oil passages is moved according to the balance between the biasing force of a spring 17a and the force that is applied by the P range pressure.

First, as shown in FIG. 5A, when the P range is selected by the shift lever, and the P range pressure is supplied to the P range input port by the switch valve 16, the spool is moved against the biasing force of the spring 17a by the P range pressure. Then, the line input port and the disengagement pressure output port are disconnected from each other (broken line in the drawing), and the output port is caused to communicate with the drain port (solid line in the drawing) so that no disengaging pressure is supplied to the parking cylinder 4. As a result, the parking rod 5 is biased by the spring 7, enabling the pawl 3b of the parking hole 3 to engage with the parking gear 2. In the present embodiment, this state is a parking engagement state.

On the other hand, as shown in FIG. 5B, if a range other than the P range is selected by the shift lever, and the P range pressure is cut off by the switch valve 16, the spool is moved by the biasing force of the spring 17a. Then, the disengagement pressure output port and the drain port are disconnected from each other (broken line in the drawing), and the line input port and the disengagement pressure output port are caused to communicate with each other (solid line in the drawing) to supply the disengagement pressure to the parking cylinder 4. As a result, the parking rod 5 is moved against the biasing force of the spring 7, disengaging the pawl 3b of the parking hole 3 from the parking gear 2. In the present embodiment, this state is a parking disengagement state.

Note that the present embodiment is not limited to the above structure, and for example, the switch valve 16 may be structured to output a not-P range pressure if a range other than the P range is selected, and not to output the not-P range pressure if the P range is selected. In this case, the relay valve 17 may output the line pressure PL as a disengagement pressure for disengaging the parking gear 2 and the parking pole 3 from each other when the not-P range pressure is supplied to the relay valve 17, and may drain the disengagement pressure when the not-P range pressure is cut off. That is, the switch valve 16 is structured to supply an oil pressure to the relay valve 17 when the operation state is one of the parking disengagement state and the parking engagement state, and not to supply the oil pressure to the relay valve 17 when the operation state is the other state. The relay valve 17 is structured to supply or not to supply the disengagement pressure according to whether or not the oil pressure is supplied from the switch valve 16.

In the present embodiment, the relay valve 17 is provided in addition to the switch valve 16. The relay valve 17 is neither bulky not complex in structure, whereby the size and cost can be reduced. The structures and functions are otherwise similar to those of the first embodiment described above.

Note that, as described above, the present invention may easily be applied even to hybrid vehicles having no automatic transmission, by providing the switch valve 16 and the relay valve 17 having such functions as described above, instead of the manual shift valve. In this case, a signal pressure that is adjusted to a lower value than the line pressure may be supplied to the switch valve 16, and the P range pressure or the not-P range pressure described above may be output as a signal pressure from the switch valve 16 to the relay valve 17.

Note that the above embodiments are described mainly with respect to the examples in which the present invention is applied to a structure having an automatic speed change mechanism. However, the present invention is also applicable to hybrid vehicles having no automatic transmission, and the like.

The vehicle hydraulic control device of the present invention can be used as a hydraulic control device that is mounted on passenger cars, trucks, buses, agricultural machines, and the like. In particular, the vehicle hydraulic control device of the present invention is preferably used as a parking mechanism in applications in which the device needs to be more compact, more lightweight, and more inexpensive to manufacture.

What is claimed is:

1. A vehicle hydraulic control device for driving a parking rod to a parking disengagement position and a parking engagement position based on an operation input of a shift selecting portion, and switching a shift range at least between a parking range and a non-parking range by switching an engagement state of a parking gear and a parking pole, the vehicle hydraulic control device comprising:
a parking cylinder that receives an oil pressure for driving the parking rod to the parking disengagement position; and
a switch valve that is driven based on an electric actuator and switches an operation state between a parking disengagement state in which a source pressure from an oil pressure supply source is supplied to the parking cylinder as a disengagement pressure for disengaging the parking gear and the parking pole from each other, and a parking engagement state in which the disengagement pressure is not supplied to the parking cylinder.

2. The vehicle hydraulic control device according to claim 1, wherein
the switch valve is a manual shift valve that sets a forward range pressure and a reverse range pressure based on the source pressure.

3. The vehicle hydraulic control device according to claim 2, wherein
the manual shift valve is structured to supply the source pressure to the parking cylinder as the disengagement pressure when a shift range is any of a forward range, a neutral range, and a reverse range, and to cut off the source pressure and drain the disengagement pressure so that the disengagement pressure is not supplied to the parking cylinder when the shift range is the parking range.

4. The vehicle hydraulic control device according to claim 3, wherein
the manual shift valve includes a plurality of ports and a spool for selectively causing the plurality of ports to communicate with or disconnect from each other based on a position to which the spool is moved,
a first drain port, a discharge port for guiding the forward range pressure to the first drain port, a forward range port for supplying the forward range pressure, an input port for receiving the source pressure, a reverse range port for supplying and discharging the reverse range pressure, and a second drain port, all of which form the plurality of ports, are sequentially positioned with respect to a direction in which the spool is moved,
ports for supplying and discharging the disengagement pressure to and from the parking cylinder, which form the plurality of ports, are positioned between the discharge port and the forward range port and between the input port and the reverse range port, and
the disengagement pressure is drained from the first drain port and the second drain port when the shift range is the parking range.

5. The vehicle hydraulic control device according to claim 2, wherein
the manual shift valve is capable of setting a neutral range pressure,
the vehicle hydraulic control device further comprises:
a check valve mechanism positioned between the manual shift valve and the parking cylinder, and capable of supplying any of the forward range pressure, the reverse range pressure, and the neutral range pressure to the parking cylinder as the disengagement pressure,
when the shift range is any of a forward range, a neutral range, and a reverse range, the range pressure corresponding to the range is supplied to the parking cylinder through the check valve mechanism as the disengagement pressure, and
when the shift range is the parking range, the range pressure is cut off by the manual shift valve, and the disengagement pressure is drained so that the disengagement pressure is not supplied to the parking cylinder.

6. The vehicle hydraulic control device according to claim 1, further comprising:
a relay valve capable of supplying the source pressure to the parking cylinder as the disengagement pressure, wherein
the switch valve is structured to supply the oil pressure to the relay valve when the operation state is one of the parking disengagement state and the parking engagement state, and not to supply the oil pressure when the operation state is the other state, and
the relay valve is structured to supply or not to supply the disengagement pressure according to whether or not the oil pressure is supplied from the switch valve.

7. The vehicle hydraulic control device according to claim 2, further comprising:
a relay valve capable of supplying the source pressure to the parking cylinder as the disengagement pressure, wherein
the switch valve is structured to supply the oil pressure to the relay valve when the operation state is one of the parking disengagement state and the parking engagement state, and not to supply the oil pressure when the operation state is the other state, and
the relay valve is structured to supply or not to supply the disengagement pressure according to whether or not the oil pressure is supplied from the switch valve.

8. The vehicle hydraulic control device according to claim 1, wherein
the parking cylinder includes a holding mechanism that holds a disengaged position of the parking rod.

9. The vehicle hydraulic control device according to claim 2, wherein
the parking cylinder includes a holding mechanism that holds a disengaged position of the parking rod.

10. The vehicle hydraulic control device according to claim 3, wherein
the parking cylinder includes a holding mechanism that holds a disengaged position of the parking rod.

11. The vehicle hydraulic control device according to claim 4, wherein
the parking cylinder includes a holding mechanism that holds a disengaged position of the parking rod.

12. The vehicle hydraulic control device according to claim 5, wherein
the parking cylinder includes a holding mechanism that holds a disengaged position of the parking rod.

13. The vehicle hydraulic control device according to claim 6, wherein
the parking cylinder includes a holding mechanism that holds a disengaged position of the parking rod.

14. The vehicle hydraulic control device according to claim 7, wherein
the parking cylinder includes a holding mechanism that holds a disengaged position of the parking rod.
